(19) United States
(12) Patent Application Publication
(10) Pub. No.: US 2008/0126141 A1
(43) Pub. Date: May 29, 2008

(54) ADDRESS DETERMINATION FOR RESIDENCY RESTRICTED OFFERS

(75) Inventors: Frank Halpin, Portland, OR (US); Brett Darrow, Phoenix, AZ (US); Duane Craw, Portland, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: GOLFNOW INC., Portland, OR (US)

(21) Appl. No.: 11/564,246

(22) Filed: Nov. 28, 2006

(51) Int. Cl. G06Q 10/00

(52) U.S. Cl. 705/5; 705/14

(57) ABSTRACT

Embodiments of the present invention provide for computerized address determination for residency restricted offers. Other embodiments may be described and claimed.

### TECHNICAL FIELD

Embodiments of the present invention relate to the field of computerized offerings, and more particular to providing address determination for residency restricted offers.

### BACKGROUND

Tee-time reservations and bookings are increasingly made through automated systems over the Internet. Enforcement of a residents-only policy, often found in golf courses operating in destination markets, may be complicated if an automated reservation and booking system does not adequately screen for compliance with these policies. Furthermore, a simple query to the person making the reservation at the time of the booking may be insufficient without something to attest to the veracity of the response.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 illustrates a reservation and booking network in accordance with various embodiments of this invention;

FIG. 2 illustrates a residency restriction section of a webpage in accordance with various embodiments of this invention;

FIG. 3 illustrates a webpage rendered on a client's computing device in accordance with various embodiments of this invention;

FIG. 4 illustrates a popup providing details about a residency restriction in accordance with various embodiments of this invention;

FIG. 5 illustrates a flowchart describing operation of an inventory manager in accordance with various embodiments of this invention; and

FIG. 6 illustrates structures of a computing device in accordance with various embodiments of this invention.

### DETAILED DESCRIPTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

For the purposes of this description, the phrase “A and/or B” means (A), (B), or (A and B); and the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

As used herein, reference to a “component” may refer to a hardware, a software, and/or a firmware component employed to obtain a desired outcome. Although only a given number of discrete components may be illustrated and/or described, such components may nonetheless be represented by additional components or fewer components without departing from the spirit and scope of embodiments of the invention.

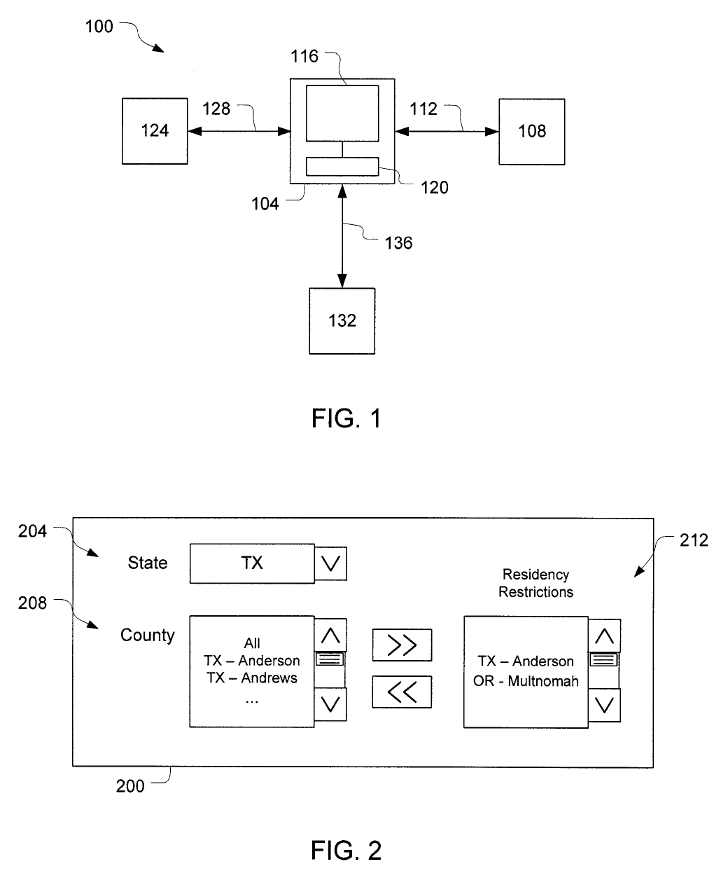

FIG. 1 illustrates a reservation and booking (RB) network 100 in accordance with various embodiments of the present invention. In this embodiment, an RB computing device 104 may be coupled to a client computing device 108 through a communication link 112. The RB computing device 104 may include a database 116 configured to store inventory assets belonging to one or more parties.

As used herein, an “inventory asset,” which may also be referred to simply as an “asset,” may be a good or service belonging to a party that is made available for retail to a client; a “service” may include a party allowing a client to use the party's facilities, e.g., stay in a hotel room or play a round of golf; and a “client” may refer to an individual engaged in negotiation of a purchase of one or more of the inventory assets.

The database 116 may also include residency restriction policies that may correspond to selected ones of the inventory assets. Briefly, the residency restriction policies may provide limitations on the allocation of the inventory assets based on the resident status of the client.

The RB computing device 104 may also include an inventory manager 120 (hereinafter “manager 120”) coupled to the database 116. The manager 120 may facilitate communication amongst the various components of the RB network 100 directed towards uploading, defining, and allocating the inventory assets stored in the database 116.

Communication between the components of the RB network 100 may take place in accordance with any of a number of network protocols, topologies, or architectures. For example, in an embodiment, the RB computing device 104 may include a server to communicate with a browser of the client computing device 108 through, for example, a variety of HTTP transmissions. Interaction between the client at the client computing device 108 and the manager 120 at the RB computing device 104 may be controlled through web documents, e.g., webpages, communicated through the communication link 112.

A party, e.g., a facility operator, having control of inventory assets may have access to the RB computing device 104 through a facility's computing device 124 over communication link 128. The facility operator may upload inventory assets to the database 116 for management by the manager 120. This may allow for inventory assets of multiple parties to be managed by the RB computing device 104. Alternatively, the RB computing device 104 may be locally maintained by the facility operator.

In addition to uploading the inventory assets to the database 116, the operator of the facility's computing device 124 may also upload the residency restrictions associated with the inventory assets. FIG. 2 illustrates a residency restriction (RR) section 200 of a webpage rendered by a browser operating on the facility's computing device 124 in accordance with various embodiments of this invention. The RR section 200 may have a state portion 204 to allow the operator to select a state residential area and a county portion 208 to allow the operator to select a county residential area. A residency restrictions portion 212 may display the selected residential areas. If no selections are made for an associated inventory asset, there may be no residency restrictions for that asset. Upon submission, the residency restrictions may be communicated to the RB computing device 104 and uploaded to the database 116 by the manager 120.

The client, through a webpage rendered by a browser at the client computing device 108, may initialize an RB operation by providing the manager 120 with search criteria relating to desired inventory assets. The manager 120 may respond to the client with a computerized offering of any unallocated inventory assets from the database 116 that satisfy the client's search criteria. The client may then select an unallocated inventory asset for booking.

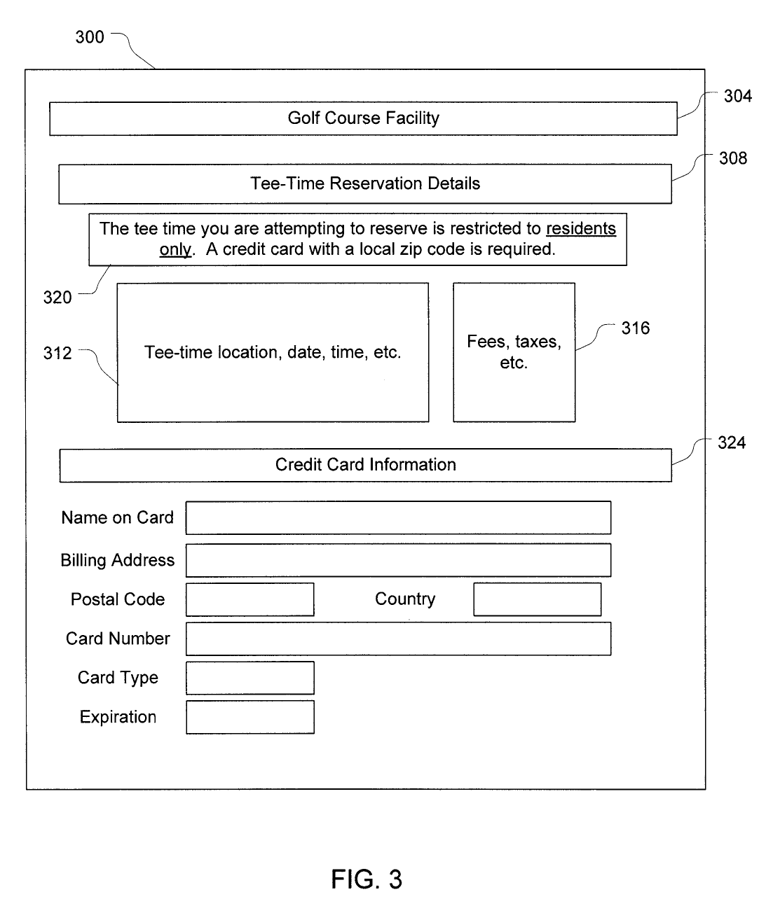

FIG. 3 illustrates a webpage 300 that may be rendered by a browser operating on the client computing device 108 prior to the consummation of an RB operation in accordance with various embodiments of this invention. The manager 120 may access the information about the selected asset stored in the database 116 and populate the fields of the webpage 300 for the client's confirmation.

As shown, the webpage 300 may provide information relating to the facility offering the asset in section 304. In this embodiment, the offering facility may be a golf course facility. The webpage 300 may show details about the selected asset, e.g., a tee-time reservation, in section 308. The details about the tee-time reservation may include event details 312, e.g., location, date, time, etc., and/or costs 316 (e.g., fees, taxes, etc.). The details may also include a residency restriction policy 320 associated with the tee-time reservation. The residency restriction policy 320, of this embodiment, may state that the associated tee time is restricted to residents only and certain transactional information, e.g., a credit card number, with a local zip code may be required.

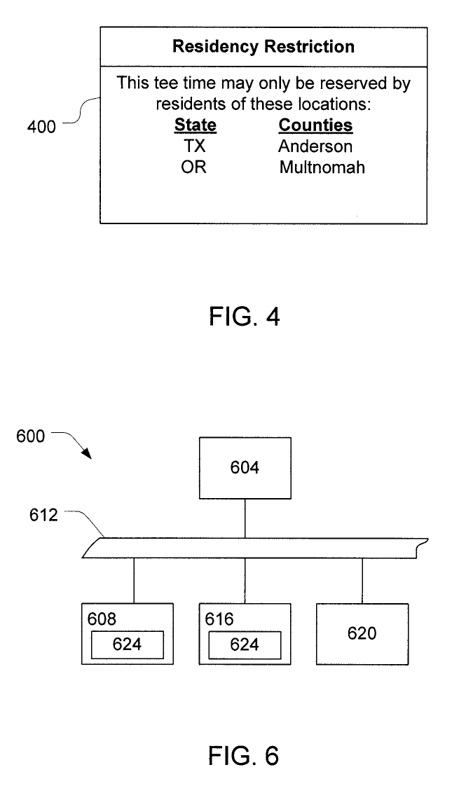

In this embodiment, the client may select the “residents only” text for a link to the particular states and/or counties of residence that qualify for this transaction. A popup box 400 providing more detailed information about the residency requirements associated with this asset is illustrated in FIG. 4 in accordance with an embodiment of this invention. In an embodiment, the popup box 400 may be a navigation popup box that appears when the user positions a mouse cursor over the link. In another embodiment, the popup box 400 may be a popup that opens upon activation of the link.

The webpage 300 may also provide section 324 to be used for inputting transactional information to allow the manager 120 to determine the resident status of the client. This determination, as will be discussed in more detail below, may involve a request to a third party to provide at least a degree of independence from a client's assertion of resident status. In this embodiment, the transactional information may be billing information provided by the client, e.g., credit card information (as shown in section 324) or any other banking card information (e.g., automated teller machine (ATM) card number, debit card number, etc.). However, in other embodiments, the transactional information may include any information that may be utilized by the manager 120 to determine the resident status of the client. For example, in an embodiment the transactional information may include identification information about the client, e.g., client's name and address. This identification information may be cross-referenced with a general residential directory, e.g., a white pages directory.

As used herein, determining residential status of the client may include both verification of resident status information originally provided by the client and derivation of the resident status from non resident information provided by the client.

In an embodiment, the manager 120 may send the transactional information as a query to an institutional computing device 132 by way of communication link 136 in order to determine the resident status of the client. The institutional computing device 132 may be operated by an institution independent from the client so that the validity of the determined resident status is removed from an assertion made by the client. In an embodiment where the transactional information includes the billing information, the institutional computing device 132 may be maintained by a financial institution associated with the credit card. The institutional computing device 132 may use the provided transactional information to reference a residential directory and provide a response to the manager 120 that includes indicia of the resident status of the client. In various embodiments, indicia of resident status may be an address of the client (with an appropriate degree of particularity) or a verification of address information provided to the institutional computing device 132.

Having determined the resident status of the client, the manager 120 may proceed with allocation of the selected inventory based at least in part on determined resident status and residency restriction policy. In various embodiments, proceeding with allocation of the selected inventory asset may include, e.g., receiving payment information, confirmation of transaction, authorization of payment, reservation of the selected asset, etc.

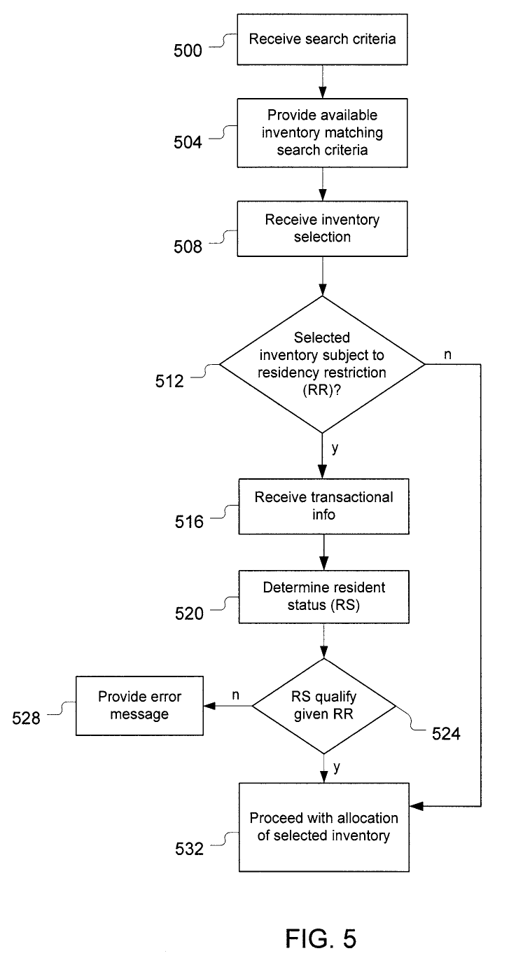

Thus operation of the manager 120 may be described with reference to the flowchart of FIG. 5 in accordance with various embodiments of the present invention. The manager 120 may receive search criteria from a client in block 500. The manager 120 may access the inventory assets stored in the database 116 to provide unallocated inventory assets matching the received search criteria in block 504. The manager 120 may receive a client's selection of an inventory asset in block 508. The manager 120 may access the resident restriction policies stored in the database 116 to determine whether the selected inventory asset is subject to a residency restriction in block 512.

If the selected inventory asset is subject to a residency restriction, the manager 120 may proceed to receive transactional information from the client at block 516. The manager 120 may use the transactional information to determine the resident status of the client at block 520. The manager 120 may then check to see if the determined resident status qualifies for the transaction given the residency restriction at block 524. If not, the manager 120 may provide an error message at block 528. The error message may state, in effect, that this transaction for the selected inventory asset cannot be consummated due to a failure of the client's resident status to qualify given the residence restriction associated with the selected asset. If the client's resident status does qualify the client for the transaction given the residence restriction, the manager 120 may proceed with allocation of the selected inventory to the client at block 532.

In various embodiments, if it is determined that the selected inventory asset is subject to a residency restriction at block 512, the manager 120 may notify the client of the residency restriction including, e.g., the states and/or counties to which the offer is restricted, and any other relevant policies, e.g., requirement to show identification at a golf course at the time of play. The manager 120 may also request that the client agree to determination of resident status prior to proceeding. If the client agrees, the manager may then request the transactional information at block 516.

If the selected inventory asset is determined to not be subject to a resident restriction at block 512, the manager 120 may skip blocks 516-528 and may proceed directly to allocation of selected inventory asset at block 532.

In various embodiments, qualification at block 524 and proceeding with allocation at block 532 may be done so in matters of degree. For example, in an embodiment a resident status of a client may qualify the client for one of a number of levels of the residency restriction. Each of the levels may have an associated cost for which the inventory asset may be charged to the client. For example, a non resident may be allowed to proceed with the transaction but may be required to pay a higher price for the inventory asset than a resident.

FIG. 6 illustrates a computing device 600 capable of implementing the RB computing device 104 in accordance with various embodiments of this invention. As illustrated, for the embodiments, computing device 600 includes one or more processor(s) 604, memory 608, and bus 612, coupled to each other as shown. Additionally, computing device 600 includes storage 616, and one or more communication interface(s) 620 coupled to each other, and the earlier described elements as shown.

Memory 608 and storage 616 may include in particular, temporal and persistent copies of RB logic 624, respectively. The RB logic 624 may include instructions that when accessed by the processor(s) 604 result in the computing device 600 performing operations or executions involved with various embodiments of this invention. In particular, the accessing of the RB logic 624 by the processor(s) 604 may facilitate inventory manager operations such as those described above with reference to the manager 120.

In various embodiments, the memory 608 may include RAM, dynamic RAM (DRAM), static RAM (SRAM), synchronous DRAM (SDRAM), dual-data rate RAM (DDRRAM), etc.

In various embodiments, the processor(s) 604 may include one or more single-core processors, multiple-core processors, controllers, application-specific integrated circuits (ASICs), etc.

In various embodiments, storage 616 may include integrated and/or peripheral storage devices, such as, but not limited to, disks and associated drives (e.g., magnetic, optical), universal serial bus (USB) storage devices and associated ports, flash memory, read-only memory (ROM), non-volatile semiconductor devices, etc. Storage 616 may be a storage resource physically part of the computing device 600 or it may be accessible by, but not necessarily a part of, the computing device 600. For example, the storage 616 may be accessed by the computing device 600 over a network.

In various embodiments, computing device 600 may have more or less elements, and/or different architectures.

Although certain embodiments have been illustrated and described herein for purposes of description of some embodiments, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A method comprising:
receiving, by a computing device, a selection of an inventory asset from a client, said inventory asset being associated with a residency restriction policy;
receiving, by the computing device, transactional information from the client;
determining, by the computing device, a resident status of the client based at least in part on said received transactional information; and
proceeding, by the computing device, with an allocation of the inventory asset to the client based at least in part on said determined resident status and said residency restriction policy.

2. The method of claim 1, wherein said determining of a resident status of the client comprises:
generating and transmitting, by the computing device, a query including said received transactional information to an institution; and
receiving, by the computing device, indicia of the resident status of the client from the institution.

3. The method of claim 2, wherein said transactional information includes credit card information and said generating and transmitting of a query to an institution comprises:
transmitting the query to a financial institution associated with the credit card information.

4. The method of claim 1, wherein the inventory asset comprises a golf tee time.

5. The method of claim 1, further comprising:
receiving, by the computing device, the residency restriction policy from a party making available the inventory asset.

6. The method of claim 1, wherein said residency restriction policy comprises state and/or county residency requirements.

7. The method of claim 1, further comprising:
receiving, by the computing device, search criteria from the client; and
providing, by the computing device, an offering of one or more inventory assets, including the inventory asset, in response to received search criteria.

8. The method of claim 7, wherein said providing of an offering to a client further comprises:
providing, by the computing device, the offering of one or more inventory assets to the client by way of another computing device.

9. An apparatus comprising:
a database having a plurality of inventory assets; and
an inventory manager communicatively coupled to the database and configured to receive a selection, from a client, of an inventory asset of the plurality of inventory assets, said selected inventory asset being associated with a residency restriction policy; to receive transactional information from the client; to determine a resident status of the client based at least in part on said received transactional information; and to proceed with an allocation of the selected inventory asset to the client based at least in part on said determined resident status and said residency restriction policy.

10. The apparatus of claim 9, wherein the inventory manager is further configured to generate and transmit a query including said received transactional information to an institution; and to receive, in response to the query, an indicia of the resident status of the client from the institution.

11. The apparatus of claim 10, wherein said transactional information includes credit card information and the inventory manager is further configured to transmit the query to a financial institution associated with the credit card information.

12. The apparatus of claim 9, wherein the plurality of inventory assets comprises a plurality of golf tee times.

13. The apparatus of claim 9, wherein the inventory manager is further configured to receive the residency restriction policy from a party making available the plurality of inventory assets.

14. The apparatus of claim 9, wherein said residency restriction policy comprises state and/or county residence requirements.

15. A machine-accessible medium having associated instructions, which, when accessed, results in a machine:
receiving, by a computing device, a selection of an inventory asset from the client, said inventory asset being associated with a residency restriction policy;
receiving, by the computing device, transactional information from the client;
determining, by the computing device, a resident status of the client based at least in part on said received transactional information; and
proceeding, by the computing device, with an allocation of the inventory asset to the client based at least in part on said determined resident status and said residency restriction policy.

16. The machine-accessible medium of claim 15, wherein the associated instructions, when accessed, further results in the machine:
generating and transmitting, by the computing device, a query including said received transactional information to an institution; and
receiving, by the computing device, indicia of the resident status of the client from the institution.

17. The machine-accessible medium of claim 16, wherein the associated instructions, when accessed, further results in the machine:
generating and transmitting the query to a financial institution associated with the transactional information.

18. The machine-accessible medium of claim 15, wherein the inventory asset comprises a golf tee time.

19. The machine-accessible medium of claim 15, wherein the associated instructions, when accessed, further results in the machine:
receiving the residency restriction policy from a party making available the inventory asset.

20. The machine-accessible medium of claim 15, wherein the associated instructions, when accessed, further results in the machine:
receiving search criteria from the client; and
providing an offering of one or more inventory assets, including the inventory asset, in response to received search criteria.
